(19) United States
(12) Patent Application Publication
(10) Pub. No.: US 2018/0025215 A1
(43) Pub. Date: Jan. 25, 2018

(54) ANONYMOUS LIVE IMAGE SEARCH

(71) Applicant: Captoria Ltd., St Albans Hertfordshire (GB)

(72) Inventors: Yaacoub YOUSEF, Chelmsford (GB); Izlam SHALAAN, Chelmsford (GB); Tom MARTIN, St. Albans (GB)

(21) Appl. No.: 15/556,247

(22) PCT Filed: Sep. 30, 2015
(86) PCT No.: PCT/GB2015/052864

§ 371 Date: Sep. 6, 2017

(30) Foreign Application Priority Data
Mar. 6, 2015 (EP) 15158085.9

(51) Int. Cl. G06K 9/00; G06F 17/30

(52) U.S. Cl. CPC G06K 9/00288; G06F 17/30256; G06F 17/3028; G06F 17/30268; G06K 9/00261

(57) ABSTRACT

A method and system for managing and sharing images in an anonymised and live manner such that a third party is able to search for the most recent images that meet the search criteria without being provided with any images uploaded by the proprietor in which a person is present. The system processes images uploaded to a database, marking them as public or private based on the content of the image, and provides an information retrieval system enabling a third party to search through the images marked as public, wherein the third party is presented with the images most recently captured that fulfil the search criteria.

### TECHNICAL FIELD

The present invention relates to a system and method of live image search. In particular, the present invention relates to an algorithm used to curate an image database to provide an image search platform that is both live and anonymous.

### BACKGROUND TO THE INVENTION AND PRIOR ART

Image management applications for storing and sharing digital images are a commonly known type of software application. Such software may be used to publicly share digital images whereby a third party may search key words and be provided with images associated with the key words based on information provided by the proprietor of the image. For example, the proprietor may input information about the location of the image, events occurring within the image, or any other information relevant to the specific image. In this respect, the images provided are usually those that have been associated with particularly popular key words and are not necessarily the most recently uploaded images.

Furthermore, any curation of such image databases must be performed by the user, and not by the application itself. That is to say, should the user wish to keep particular images private, for example, images that clearly show the faces of people, they must specify that said images must not be shared publicly. Consequently, image management applications known in the art do not provide a system that automatically anonymises the images within its database such that only images without people are made available to the public, and that provides a search which produces the most recent and up to date images relevant to the search criteria, that is, a live search.

### SUMMARY OF INVENTION

Embodiments of the present invention solve the above noted problems by providing a system and method for managing and sharing images in an anonymised and live manner. The present invention processes images to remove those with faces in them, and then enables third party users to search and view the remaining images in chronological order such that they are able to view the most recently captured images relevant to their search. Such a system may be of particular use to people wishing to keep up to date with current affairs, for example, journalists looking for images of an event taking place at a particular location at that immediate moment.

The present invention comprises two stages; an image processing stage and a search and view stage. The image processing stage processes and anonymises images uploaded to its database by automatically extracting images with faces and categorising them as ‘private’. Images without faces are marked as ‘public’, and are tagged with identifying terms. The identifying terms may correspond to information such as time and location embedded in the image's metadata, or they may relate to the content of the image as provided by the proprietor of the image, for example, a key word describing an event occurring in the image. The search and view stage enables the ‘public’ images to be searched and viewed by a third party user, wherein the present invention presents the third party user with the most recent images relevant to their search, that is to say, the results are displayed in chronological order from most to least recent, or vice versa if required. In this respect, the third party user is able to view effectively ‘live’ images relevant to their search. For example, a third party user may search a particular geographical location such as Trafalgar Square. The present invention will then search for all images associated with the term ‘Trafalgar Square’ and display them in chronological order based on the time it was captured, such that the most recent image is displayed first. In this respect, the third party user may be able to see images of Trafalgar Square that have been taken just moments before.

In order to solve the problems associated with prior art systems, the present invention provides an image processing method comprising the steps of:
receiving at least one image file from a client application;
analysing the at least one image file to determine whether the image includes a face;
if the image includes a face, assigning the image file to a first group of images, wherein the first group of images is accessible by a client application having a first user profile; and
if the image does not include a face, assigning the image file to a second group of images, wherein the second group of images is accessible by a client application having a second user profile.

The first user profile includes the client application from which the at least one image is received, that is, the proprietor of the image. The first user profile may further include other client applications that have been given permission to access the image by the client application from which the at least one image is received. The second user profile is thus a public profile, such that images that do not include a face are publicly available.

In some embodiments, the step of receiving comprises storing the at least one image file in a first database. The step of receiving may further comprise receiving instructions from the client application to label the image file with at least one identifying term, wherein the identifying term may be based on at least one of the geographical location where the image was captured, the time at which the image was captured and the visual content of the image.

According to further embodiments, the step of analysing the at least one image file further comprises inputting the image file to a face detection application programming interface (API). The predetermined visual feature may include at least one of an eye, a nose, an ear and/or a mouth.

In another embodiment, the step of analysing the at least one image file further comprises extracting metadata information embedded in the image file, wherein the metadata information may include at least one of the geographical location where the image was captured and the time at which the image was captured.

In other embodiments, the step of analysing the at least one image further comprises inputting the image file to a content detection application programming interface (API). The step of analysing the at least one image may further comprise inputting the image file to a resolution application programming interface (API).

The step of analysing the at least one image file may further comprise labelling the image file with at least one identifying term based on the geographical location at which the image was taken.

The step of analysing the at least one image file may comprise inputting the image file to a content detection application programming interface, API. The step of analysing the at least one image file may then further comprise labelling the image file with at least one identifying term based on the content detected by the content detection API.

In one embodiment, the step of processing the image file to allow it to be accessed by a client application of the first user profile comprises labelling the image file as private and storing the image file in a first database. Storing the image in first database may include placing it in a private table of images. The step of processing the image file to allow it to be accessed by a client application of the first user profile may further comprise storing the image in a second database accessible to a client application of the first user profile. As discussed above, the first user profile may include the client application being used by the proprietor of the image.

In another embodiment, the step of processing the image file to allow it to be accessed by a client application of a second user profile comprises labelling the image file as public and storing the image file in the first database. Storing the image in the first database may include placing it in a public table of images. The step of processing the image file to allow it to be accessed by a client application of a second user profile may further comprise storing the image in a third database accessible to a client application of the second user profile. As discussed above, the second user profile may include the client application being used by the proprietor of the image and any other client applications being used by third parties.

According to some embodiments of the claimed invention, the method further comprises the steps of:
receiving instructions from a client application of the second user profile to search the images that do not include a face, wherein the instructions comprise at least one search criterion; and
displaying at least one image to the client application of the second user profile based on the received instructions.

The search criterion may include at least one of a geographical location, a time frame, an event and/or an object. The method may further comprise displaying the at least one image to the second group of client applications in a chronological order, wherein the chronological order is based on the date and time at which the image file was captured.

The image processing method may also comprise receiving at least one audio file from the client application, wherein the audio file is associated with at least one image file. Instructions may then be received from a client application of the second user profile to search the images that do not include a face based on an associated audio file.

The present invention also provides an image processing system comprising:
at least one client application running on a data processing device;
a processor; and
a computer readable medium storing one or more instruction(s) arranged such that when executed the processor is caused to perform the steps of:
(i) receive at least one image file from the client application;
(ii) analyse the at least one image file to determine whether the image includes a face;
(iii) if the image includes a face, assigning the image file to a first group of images, wherein the first group of images is accessible by a client application having a first user profile; and
(iv) if the image does not include a face, assigning the image file to a second group of images, wherein the second group of images is accessible by a client application having a second user profile.

According to embodiments of the present invention, receiving the at least one image file includes storing the at least one image file in a first database.

In some embodiments, the processor is further arranged to receive instructions from the client application to label the at least one image file with at least one identifying term. The identifying term may be based on at least one of the geographical location where the image was captured, the time at which the image was captured and the visual content of the image.

In one embodiment, the step of analysing the at least one image file comprises inputting the image file to a face detection application programming interface (API). The predetermined visual feature may include at least one of an eye, a nose, an ear and/or a mouth.

According to some embodiments, the step of analysing the at least one image file further comprises extracting the metadata information embedded in the image file. The metadata information may include at least one of the geographical location where the image was captured and the time at which the image was captured.

In other embodiments, the step of analysing the at least one image further comprises inputting the image file to a content detection application programming interface (API). The step of analysing the at least one image may further comprise inputting the image file to a resolution application programming interface (API).

According to one embodiment, the step of processing the image file to allow it to be accessed by a client application of a first user profile comprises labelling the image file as private and storing the image file in the first database, wherein the image may be placed in a private table of images. The step of processing the image file to allow it to be accessed by a client application of a first user profile may further comprise storing the image in a second database accessible to a client application of the first user profile. The first user profile may include the client application being used by the proprietor of the image.

In another embodiment, the step of processing the image file to allow it to be accessed by a client application of a second user profile comprises labelling the image file as public and storing the image file in the first database, wherein the image may be placed in a public table of images. The step of processing the image file to allow it to be accessed by a client application of a second user profile may further comprise storing the image in a third database accessible to the client application of the second user profile. The second user profile may include the client application being used by the proprietor of the image and any other client applications being used by third parties.

In some embodiments, the processor is further arranged to analyse at least one image file in response to a member of the second user profile accessing the first, second or third database.

In other embodiments, the processor is further arranged such that analysis of at least one image is initiated in response to a request from a client application. A request may include any interaction between a client application and the system, for example, a client application may request to search the image files, the request initiating a Linux “Cron job” that sends an unprocessed image to a face detection API for processing. Alternatively, a request may include uploading an image file, viewing an image file or any other client application activity within the system

In embodiments of the present invention, the processor is arranged to analyse at least one image file periodically. For example, the processor may be arranged to initiate a Cron job once every minute, wherein the Cron job is arranged to call a face detection API to process the image. The processor may be further arranged such that it analyses at least one image every second.

According to some embodiments, the processor is further arranged to perform the steps of:
receive instructions from a client application of the second user profile to search the images that do not include a face, wherein the instructions comprise at least one search criterion; and
display at least one image to the client application of the second user profile based on the received instructions.

The search criterion may include at least one of a geographical location, a time frame, an event and/or an object.

The processor may be further arranged to display the at least one image to the second group of client applications in a chronological order, wherein the chronological order may be based on the date and time at which the image file was captured.

The present invention further provides an image processing method comprising the steps of:
receiving at least one image file from a client application;
analysing the at least one image file to determine whether the image includes a face;
if the image includes a face, processing the image file to allow it to be accessed by a client application having a first user profile; and
if the image does not include a face, processing the image file to allow it to be accessed by a client application having a second user profile.

### BRIEF DESCRIPTION OF THE DRAWINGS

The present invention will now be described by way of example only, and with reference to the accompanying drawings in which:

FIG. 1 is a flow diagram illustrating the steps of the image processing stage according to embodiments of the present invention;

FIG. 2a is a block diagram illustrating apparatus according to the present invention;

FIG. 2b is a block diagram illustrating apparatus according to the present invention;

FIG. 3a is a flow diagram illustrating the steps of the search and view stage of the present invention;

FIG. 3b is a flow diagram illustrating the steps of a part of the view and search stage of the present invention;

FIG. 3c is a flow diagram illustrating the steps of a part of the view and search stage of the present invention;

FIGS. 4a-b illustrate an example of a user interface for uploading images of the present invention;

FIG. 4c illustrates an example of a user interface for uploading images as displayed on a mobile phone device;

FIGS. 5a-b illustrate an example of a user interface for searching and viewing images of the present invention;

FIG. 6 illustrates an example of a user interface for viewing a single image identified by a search of the present invention; and

FIG. 7 illustrates an example of a user interface for viewing an image on a user profile;

FIG. 8 is a flow diagram illustrating the steps of an image and audio capture process for use with the present invention;

FIG. 9a illustrates an example of a user interface for capturing images and audio as displayed on a mobile phone device;

FIG. 9b illustrates an example of a user interface for capturing images and audio as displayed on a mobile phone device;

FIG. 9c illustrates an example of a user interface for capturing images and audio as displayed on a mobile phone device;

FIG. 10 is a flow diagram illustrating the steps of an image and audio processing method for use in with the present invention.

### DETAILED DESCRIPTION OF THE DRAWINGS

The present invention provides a method and system for managing and sharing images in an anonymised and live manner such that a third party is able to search for the most recent images that meet the search criteria without being provided with any images uploaded by the proprietor in which the face of a person is present, or at least the features or characteristics of a person's face are present. The system processes images uploaded to its database, categorising them as public or private based on the content of the image, and provides an information retrieval system enabling a third party to search through the images categorised as public, wherein the third party is presented with the images most recently captured that fulfil the search criteria.

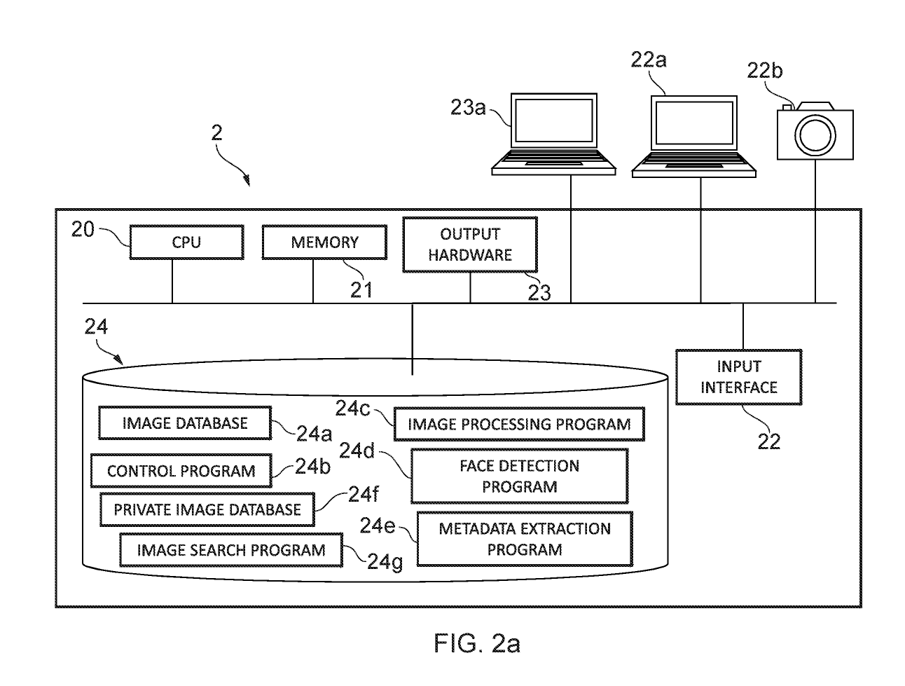

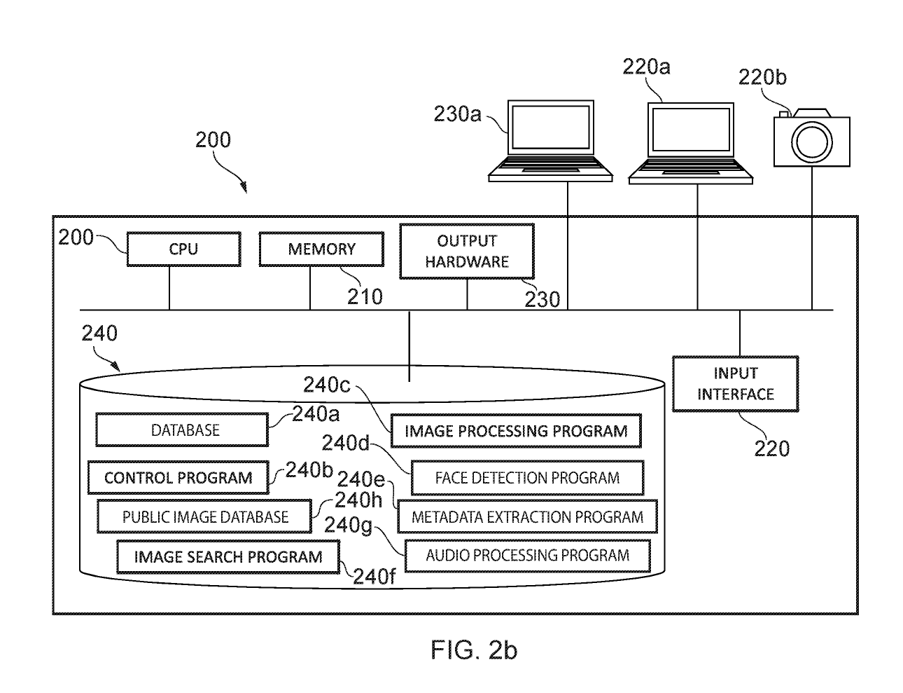

FIG. 2a illustrates an example of a general computer system 2 that may form the platform for embodiments of the invention. The computer system 2 comprises a central processing unit (CPU) 20, a working memory 21, and input interface 22 arranged to receive control inputs from a user via an input device 22a such as a keyboard, mouse, or other controller, and further inputs from an image capture device 22b such as a digital camera, video camera or any other device capable of capturing an image. The computer system 2 also comprises output hardware 23 arranged to provide output information to the user or a third party via a user interface which is displayed on an output device that may include a visual display unit 23a such as a computer screen, television, mobile device or any other device capable of providing a visual display.

The computer system 2 is also provided with a computer readable storage medium 24 such as a hard disk drive (HDD), flash drive, solid state drive, or any other form of general-purpose data storage, upon which stored data 24a and various programs are arranged to control the computer system 2 to operate in accordance with embodiments of the present invention. For example, a control program 24b may be provided and arranged to provide overall control of the system to perform the embodiments of the present invention. This control program 24b may, for example, be an application programming interface (API) arranged to receive user inputs and launch other programs to perform specific tasks. The other programs under the control of the control program 24b may include an image processing program 24c, a face detection programme 24d, a metadata extraction programme 24e, an image search programme 24f, and an audio processing program 24g.

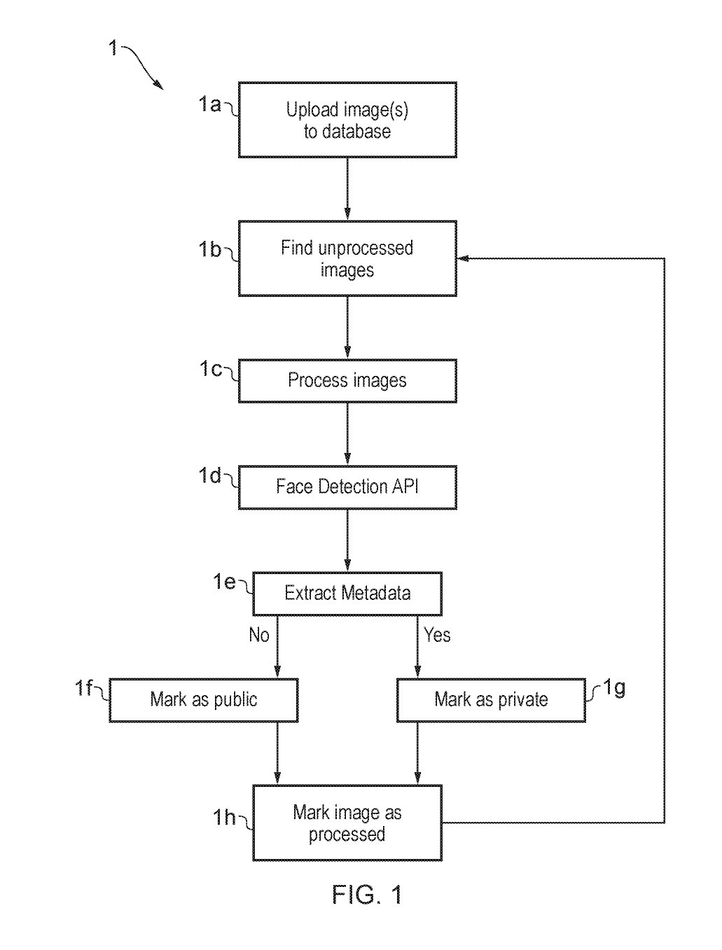

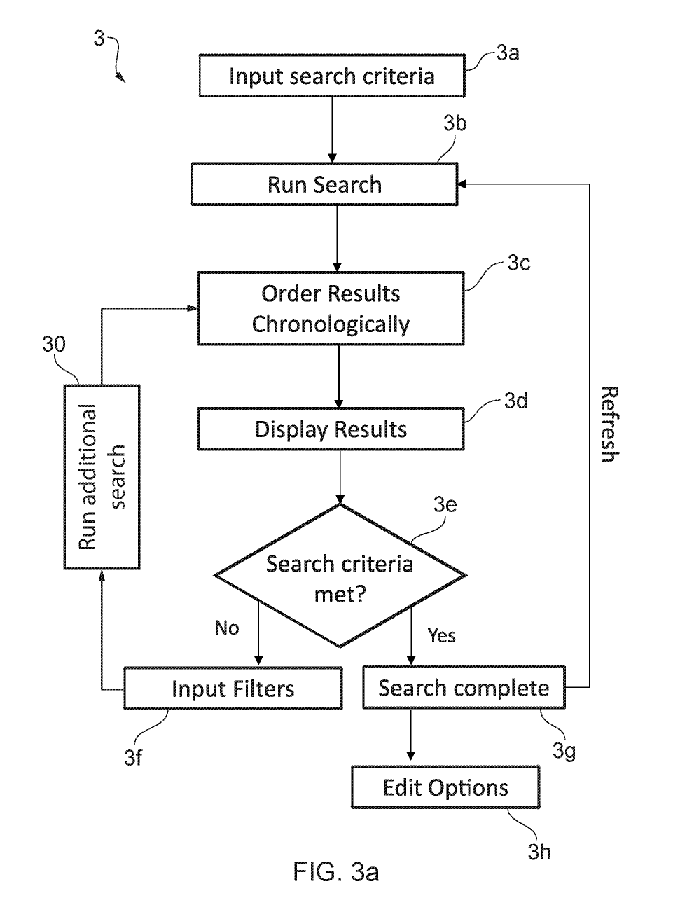

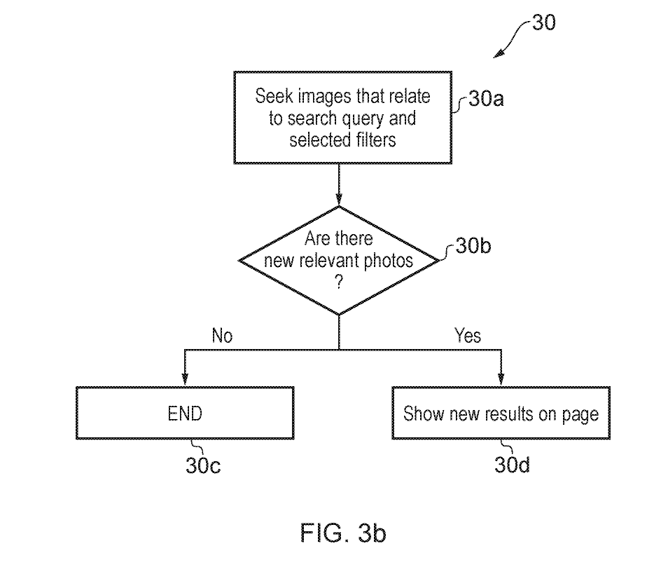

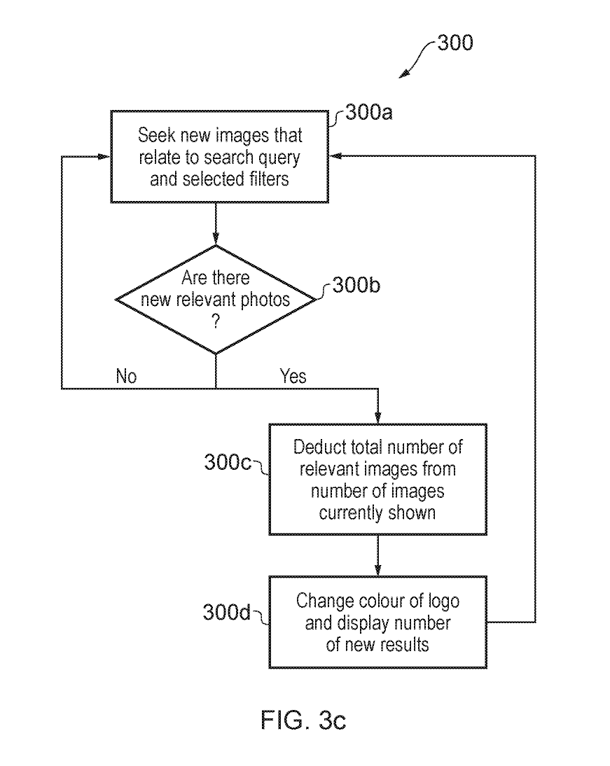

The computer system 2 is capable of performing the method and system for anonymised live image search as described by the present invention and illustrated by the steps of FIGS. 1 and 3a-c, which are described below by way of example.

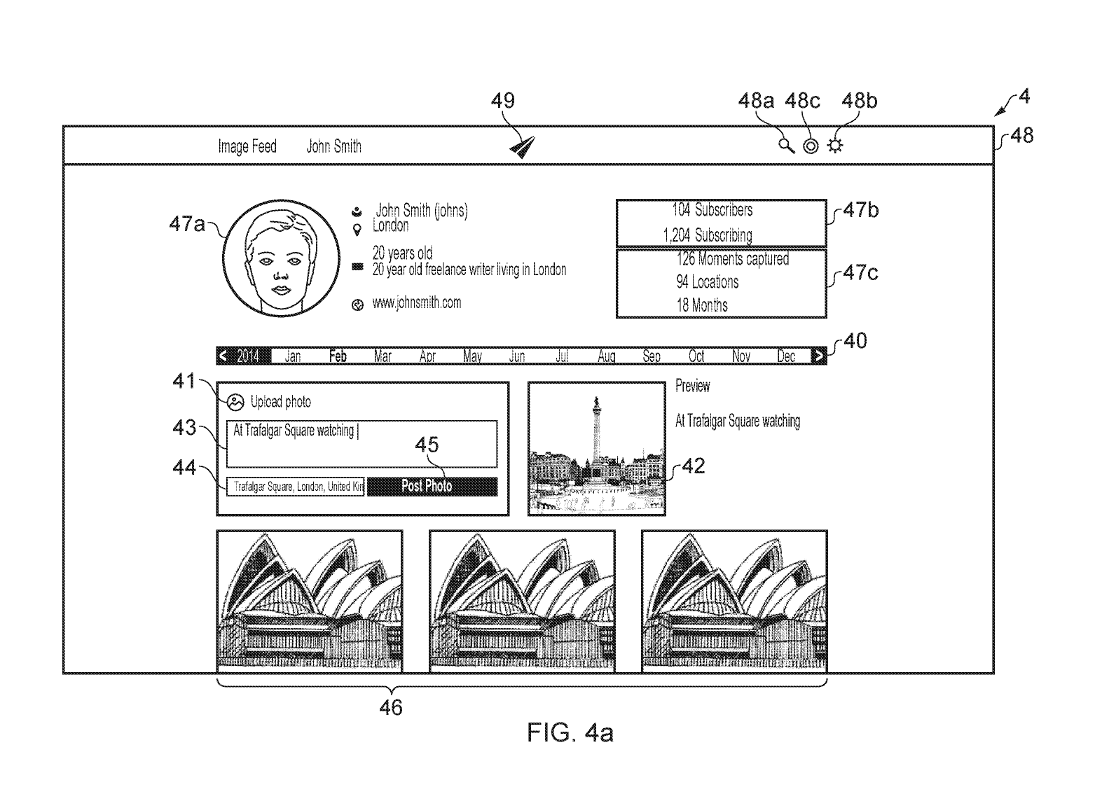

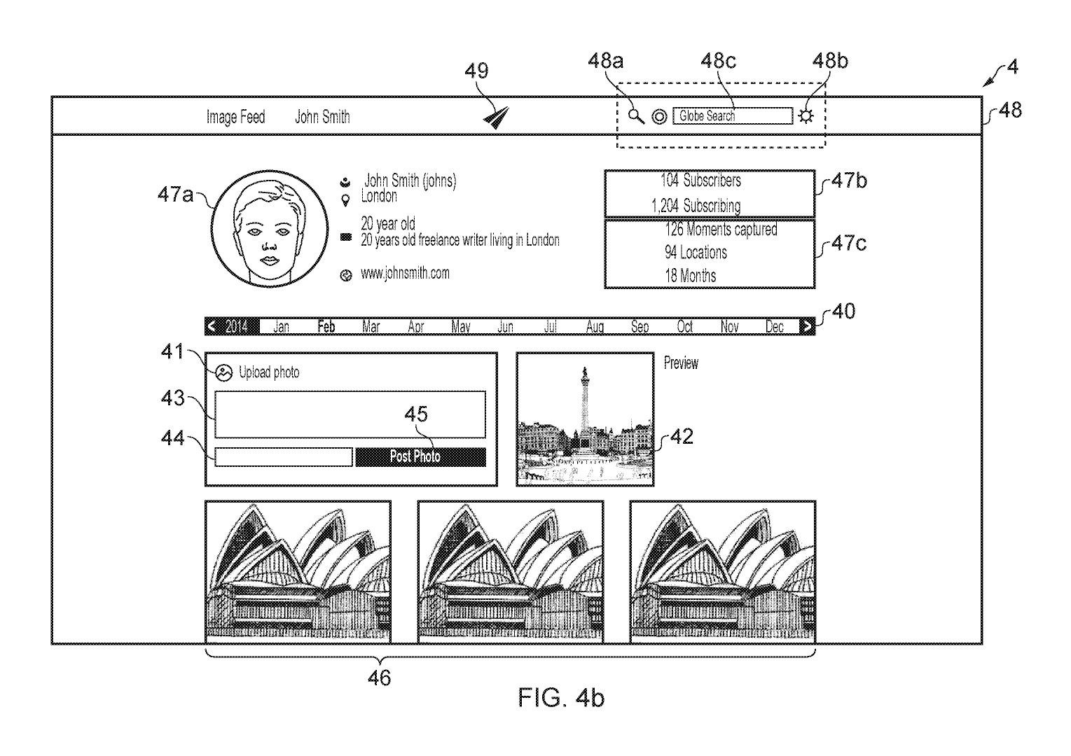

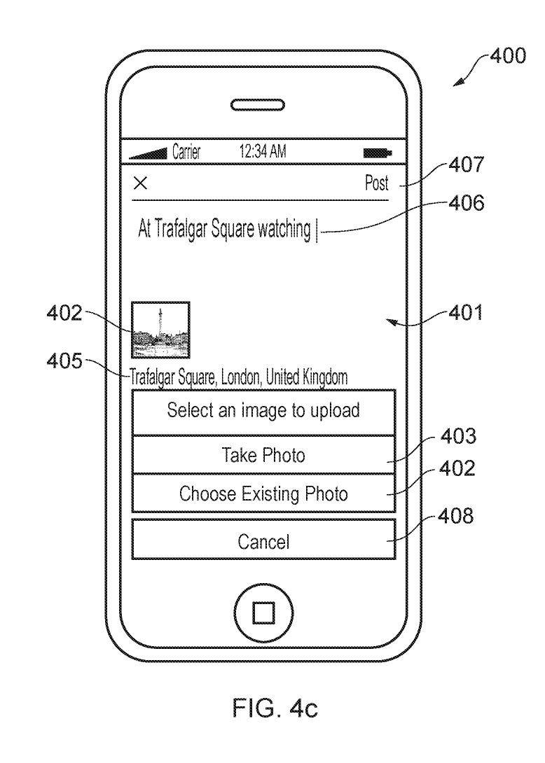

The present invention comprises two stages; an image processing stage, and a search and view stage, wherein both stages may be performed continuously and instantaneously alongside one another. FIG. 1 illustrates the image processing stage 1 that may be implemented by computer system 2 to process the images uploaded to the image database 24a according to embodiments of the present invention. This image processing stage 1 starts with a user uploading an image(s) (step 1a) to the memory 21 using an input device 22a and an image capture device 22b, the user uploading the image via a user interface 4 displayed on the input device 22a, as illustrated by FIG. 4a-b. The image capture device 22b may be an internal or external component of the input device 22a, for example, the camera of a mobile phone device, or a digital camera connected to a laptop via a USB cable. The uploading process (step 1a) starts when the user selects the upload icon 41 and chooses an image stored in the memory of the input device 22a or image capture device 22b. The uploaded images may be in any image file format, for example, JPEG File Interchange Format, GIF Graphics Interchange Format, TIFF Tag Image File Format, or any other standardized means for storing digital images.

The images is uploaded to the API of the control program 24b and displayed to the user on their input device 22a via a preview box 42. Before saving each image to the database 24a, the user may also tag the images with key words and information relating to the image, including but not exclusively, terms relating to the location of the image or the time at which the image was captured, or terms describing the content of the images. For example, the user may be presented with a first input box 43 in which the user can input words to describe the image. The user may also be presented with a second input box 44 in which the user can input words relating to the location that the image was taken. Alternatively, the location of the image may automatically be extracted from the Exchangeable Image File Format (EXIF) information embedded in the image and input to the second input box 44. This location information can then be converted into longitude and latitude co-ordinates using a location API or any other software suitable for identifying the longitude and latitude co-ordinates of the image's location. These longitude and latitude co-ordinates are then assigned to each image file. To complete the upload, the user selects a submit button 45, which stores the images and their associated data in a private table of the database 24a for processing. The user may then be able to automatically view the images uploaded 46 to their user profile so that they may edit the images, for example, tag an image with further information relating to its content or location, delete an image or, optionally, organise multiple images into groups or folders. Preferably, the images 46 uploaded to their user profile are displayed in chronological order.

The user interface 4 used by the user to upload and view their images 46, as illustrated by FIGS. 4a-b, may also function as the user's personal profile and may include personal information relating the user 47a, for example, their name, age, location, profession, profile picture, website, email address or any other relevant information that the user is willing to share. The user interface 4 may also include data regarding the number of users they have subscribed to and the number of users subscribed to their profile, as shown by box 47b. Subscription to a user allows the subscriber to view all images uploaded by the user which may include those that have been marked as public. The subscriber may also receive updates when the user has uploaded new images, which may be presented to them visually via updates icon 49 or via electronic mail received on an electronic device, or any other suitable means of providing the subscriber with an update. For example, if new images have been uploaded by the user, the updates icon 49 may change visually by means of a change in colour, presentation of a symbol or a number indicating the number of updates. The subscriber may then select the updates icon 49 to refresh the user interface 4 and display the new images. Subscription to a user may be automatically achieved, for example, by selecting a “Subscribe” icon (not shown), without requiring permission from the user to do so. Optionally, however, the user may update their settings 48b accessed by toolbar 48 such that a subscriber must first send a request to the user who can then accept or decline the request.

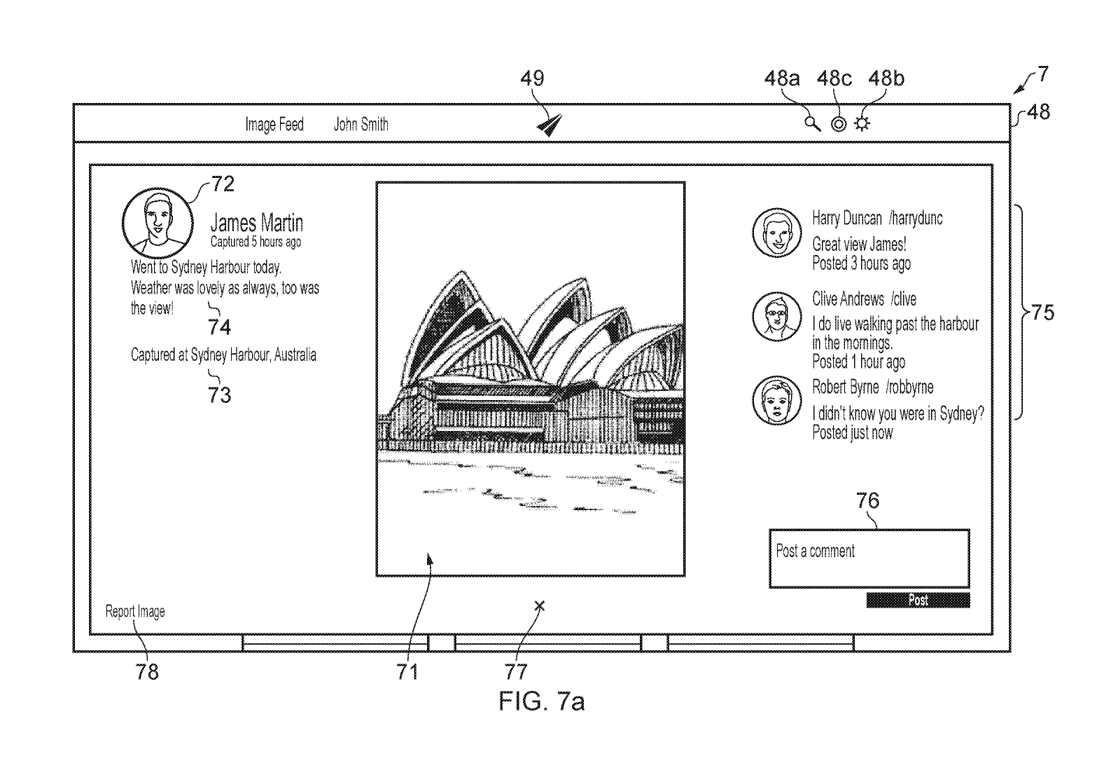

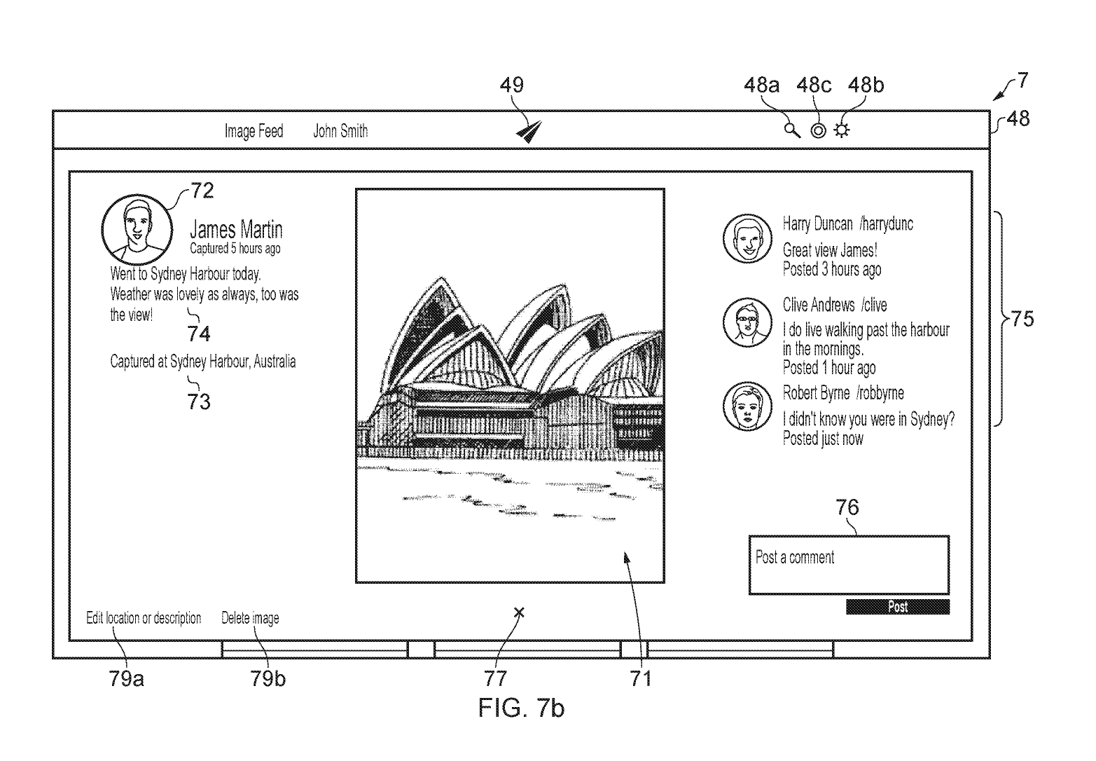

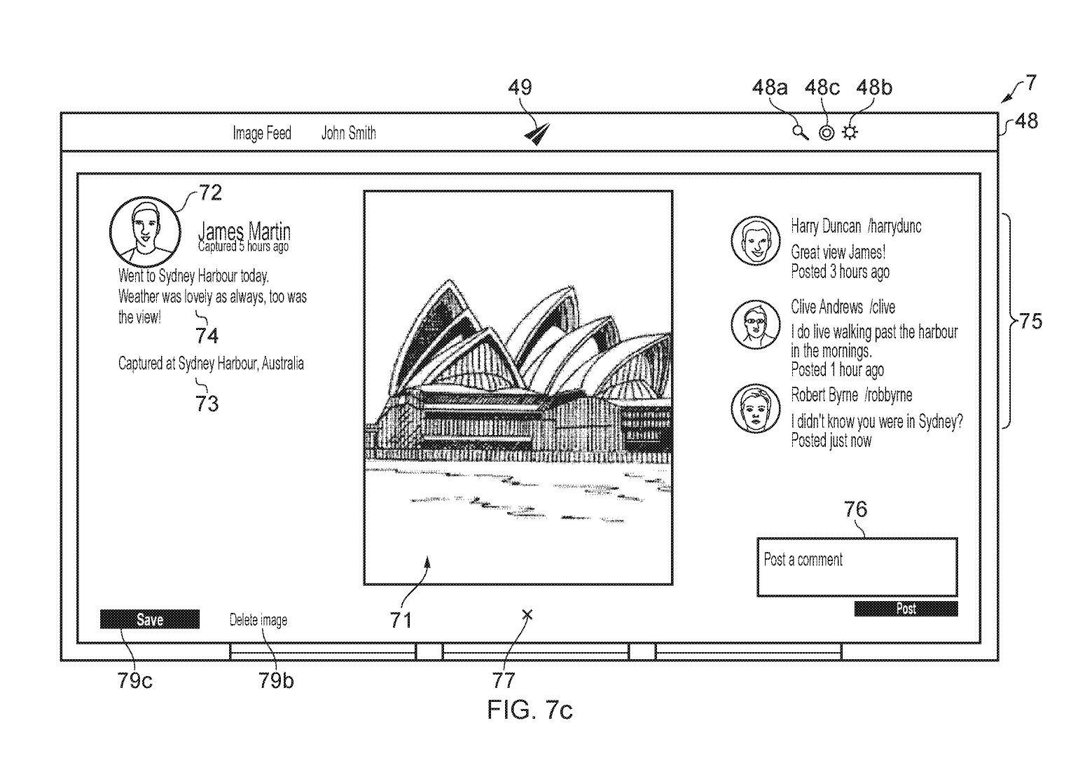

When a subscriber is viewing a user's profile, or a user is viewing their own profile, they may specify the time period for which they would like to view images using a scroll bar 40 whereby they can select a month and be presented with images that user took during the specified month. Whilst a subscriber is viewing another user's profile, or a user is viewing their own profile, the may also select an image of interest from the uploaded images 46 in order to view a full size version of the image, wherein a subscriber viewing another user's profile is illustrated by FIG. 7a, and a user viewing their own image is illustrated by FIGS. 7b-c. Upon selection of an image, the user is presented with interface 7 which displays a larger version of the image 71. The user interface 7 may include information relating to the user, for example, their name and profile picture 72. The geographical location 73 of the image, as well as any content information 74 provided by the user upon uploading the image. For example, the user may have provided a description of what they were doing when the image was taken. The user interface 7 may also provide the option for subscribers to post comments 76 about the image 71 which may also then be displayed in a user comment section 75. The user interface 7 may include a “Report Image” option 78 should they consider the image to be adverse or offensive, selection of which sends a message to the administrator informing them that the image requires their attention and may need to be removed from the platform. Once a user has finished looking at the image 71, the subscriber can select a cancel icon 77 which will take them back to the user profile as shown by FIGS. 4a-b.

When a user is viewing their own image via user interface 7, they may be presented with a “Edit description or location” icon 79a or another suitable icon to edit the location 73 or the description 74 of the image 71, or a “Delete” icon 79b to delete the image 71 from their profile, as shown in FIG. 7b. Once the user has made the desired changes to the location 73 and description 74, the user can save those changes on selection of a “Save” icon 79c, as shown in FIG. 7c.

Additionally, the user interface 4 may also display data relating to a user's posting history, as shown by box 47c, which may include information such as the number of uploaded images, the number of locations their images relate to, the period of time their images span or any other information relating to their posting activities.

The user interface 4 also includes a toolbar 48 which includes the settings icon 48b and updates icon 49, as described above. The toolbar further includes a help icon 48a whereby the client can obtain help in using the platform and problem shoot any issues they are having. Additionally, the user may use the help icon 48a to search for other users of the platform by inputting a name or key words that may be related to that user, for example, their geographical location. The toolbar 48 also includes a search icon 48a, which upon selection transforms into an input box, as illustrated by FIG. 4b. The search input box 48c may then be used to search for public images, as will be discussed in more detail below.

As illustrated by FIG. 4c, a user may use a mobile phone device 400 to upload images via user interface 401. To upload an image, the user may select an existing image 402 from the memory of the mobile device 400 or choose to capture a new image 403 using a camera device integrated to the mobile phone device 400. Once an image has been selected or captured, the image is presented to the user as an icon 404 via user interface 401. The image may be tagged with information relating to the geographical location of the image 405, whereby this geographical information may be provided automatically via the GPRS capabilities of the mobile device 400, manually by the user or automatically extracted from the Exchangeable Image File Format (EXIF) information embedded in the image. This location information can then be converted into longitude and latitude co-ordinates using a location API or any other software suitable for identifying the longitude and latitude coordinates of the image's location. These longitude and latitude co-ordinates are then assigned to each image file. The user may also input information 406 regarding the content of the image, for example, for an image captured at Trafalgar Square, the user may input “At Trafalgar Square watching a brass band”.

Classifiers may also be used in order to provide the user with suggested key words and information with which to tag each image. For example, a classification API may be used to suggest content information based the geographical location of the image, or conversely, suggest geographical location based on the content. Once the image has been tagged with information, the classification API will search for classifiers associated with this information.

Such classifiers may be programmed into the classification API manually, or developed by the classification API by searching and analysing images previously uploaded to the database 24a. Therefore, based on an initial piece of information, the classification API will predict what other information may be relevant to the new image and present them to the user as options. For example, having determined that the image was taken in “Wembley Stadium”, the classification API may suggest tags such as “watching football match” or “watching a band” based on the classifiers associated with “Wembley Stadium”.

The user may then upload the image to the platform by selecting “Post” 407 which sends the image and its associated data to the database 24a for processing. The user is also presented with a “Cancel” option 408 should they decide not to upload an image to the platform.

Whilst images are being uploaded by the users of the platform, the control program 24b will launch the image processing program 24c to search for any unprocessed images (step 1b) within the private table of database 24a. If the image processing program 24c identifies an unprocessed image, for example, an image recently uploaded, the image processing program 24c will initiate the processing of that image (step 1b), firstly, by automatically resizing the image if required. For example, if an uploaded image has a width of over 1500 pixels, the image is preferably resized to 1000 pixels. If the image is under 1000 pixels in size there is no need to resize the image. A copy of the original image is created and stored in the database 24a regardless of whether resizing has been necessary. The control program 24b will then launch the face detection program 24d which passes the resized image through a face detection application programming interface (API) or any other suitable face detection software (step 1d) to determine whether any faces are present in the image. If the face detection API does not detect a face, the face detection API will return a certainty value of 0, and if the face detection API does detect a face, it will return a certainty value of 1.

Preferably, the face detection software can detect faces from various angles, multiple faces in a photo simultaneously, with or without facial additions such as sunglasses or spectacles, as well as detect a range of expression and emotive characteristics, for example, the system can detect whether a person is smiling, have their eyes open or lips sealed. Preferably, the software can source the location of eyes, nose, mouth and many other facial points for each face detected, and determine the gender and age of the individuals. The system can also distinguish the faces of humans from the faces of animals such that images containing the faces of animals will produce a result of 0. The face detection API will return a value of 1 if any faces have been detected, even if the face detected has a low certainty, for example if the image is blurred. However, the face detection API will not return a value of 1 if the face detected has a certainty below a threshold value such that the detected face has a very low certainty of it actually being a face or at least a visibly recognisable face, for example, a certainty below 10%.

If the face detection API does not detect a face, the control program 24b will first launch a metadata extraction program 24e (step le) which will extract the metadata, that is, the embedded Exchangeable Image File Format (EXIF) information in each image file, for example, date, time and location information, or information relating to the device 22b on which the image was captured. The image processing program 24c will then mark the image as public (step lf), return the image to the private table of the database 24a, and then copy the image to a public table within the database 24a where it will be accessible to a third party, preferably, a subscriber to the platform, in the search and view stage 3.

Alternatively, the image will be sent directly to another publicly available database 240h, as shown by FIG. 2b, from which it will be searchable by a third party, preferably, a subscriber to the platform, in the search and view stage 3.

The image processing program 24c will then mark the image as processed (step 1h) and then restart the processing stage 1 by searching for further unprocessed images.

If the face detection API does detect a face, the control program 24b will first launch the metadata extraction program 24e to extract the EXIF information from the image which will be saved to the database 24a. Data may also be provided by the face detection program 24d, wherein the data relates to content of the image, for example, how many faces are in an image, the percentage certainty that person “X” is smiling, how many people in an image are female or any other information relating to the results of the face detection. The data collected by the database 24c may be used for any number of purposes, including but not exclusively, marketing and analysis purposes.

The control program 24b will then launch the image processing program 24c to mark the image as private (step 1g) such that the image will not be searchable by a third party in the search and view stage. At this point, images marked as private may be returned to the private table in the database 24a, or they may be moved or copied to a separate private database (not shown) which may only be accessed by the proprietor of the image, or optionally by subscribers to the user's profile, as described above. Alternatively, the image may automatically be sent to such a private database without being marked first. The image processing program 24c will then mark the image as processed (step 1h) and then restart the processing stage 1.

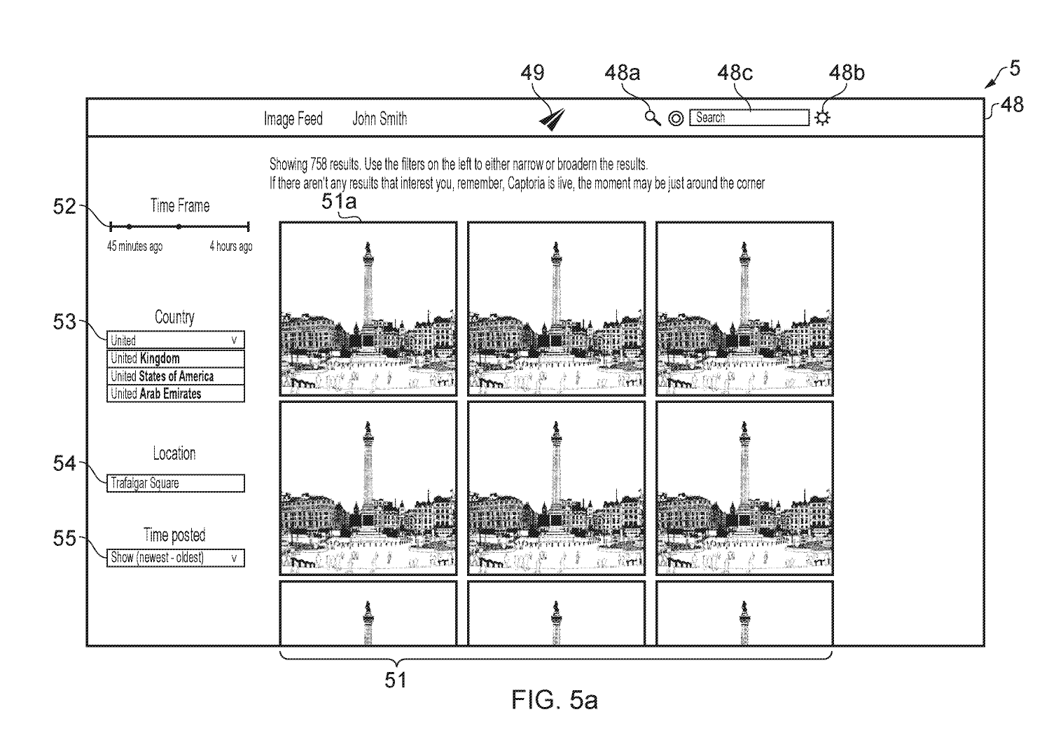

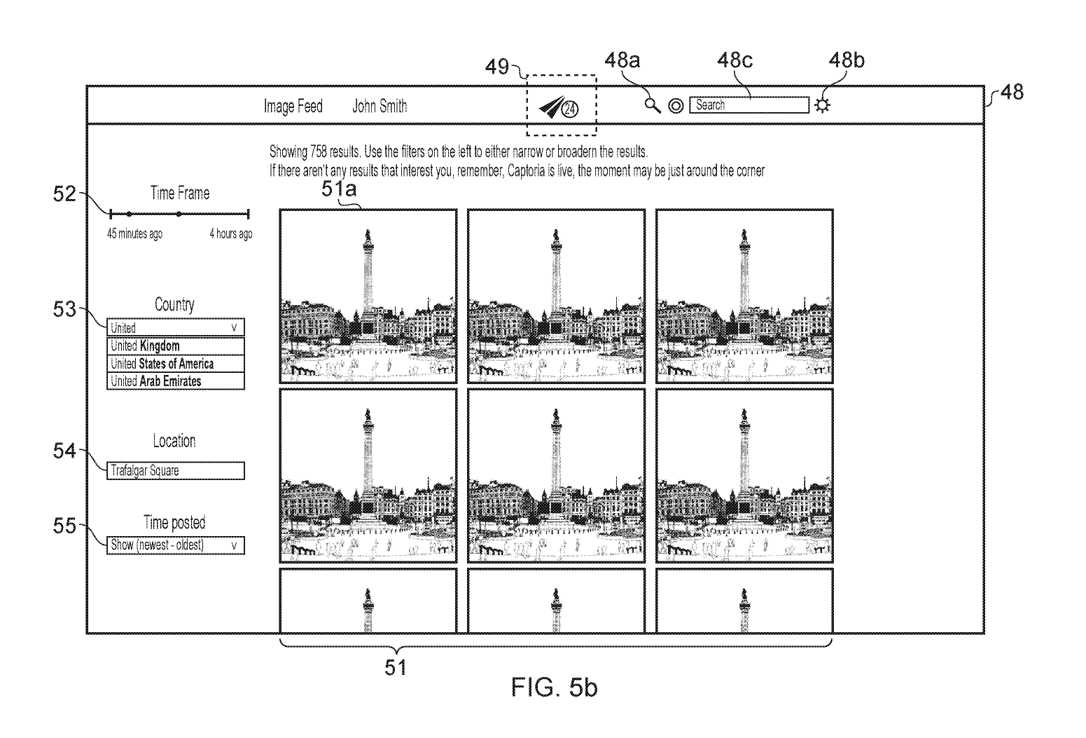

The image processing stage 1 can process any number of images at one time, although the image processing program 24c will be arranged to process one image per second for every user using the platform to search and view images. The image processing program 24c uses a time based job scheduler (e.g. a Linux Cron job) to automatically process an image every minute. In this respect, as images are uploaded to the database 24a they are automatically placed into the private table and flagged as unprocessed. The Cron job is launched every minute, and begins by putting the images contained in the private table into a chronological order. This order may run from newest to oldest, that is, the most recently uploaded image is at the top of the list, or from oldest to newest, that is, the image which has been in the table for the longest period is at the top of the list. The Cron job then sorts through the list of images, and selects the first unprocessed image in the list. This image is then sent to the face detection API which will identify any faces in the image, as described above. The image processing program 24b will then proceed to mark the image as private (step 1g) or public (step 1f) and place the image in the public table within the image database 24a. Whilst there are no clients accessing the platform to search and view images, the Cron job will run once every minute. However, for every request received from client device, the Cron job will be prompted to run every second, that is to say, it will process an image every second for every user accessing the platform. For example, if 100 photos are uploaded in 1 second and there are 100 clients searching and viewing images, those 100 photos will be processed in 1 second; if there were 100 photos uploaded in 1 second, but there were only 50 clients searching and viewing images, then 100 photos will be processed in 2 seconds; or if there were 100 photos uploaded in 1 second, but there were 200 clients searching or viewing images, then the 100 uploaded photos will still be processed in 1 second. As such, the search and view user interfaces, as illustrated by FIGS. 5a-c and 6, can function as the trigger for processing an image. That is to say, every time a user accesses one of the search and view interfaces, the image processing program 24c is prompted to process an image. A request from a client device may also include accessing any other user interface described herein, uploading an image, performing a search itself, or any other client activity within the platform. Further processing of images may also be performed when a user has been editing their own images, as illustrated by FIGS. 7b-c, wherein those images have already been processed a first time. Upon selecting the “Save” icon 79c, the image 71 will be passed through the image processing program 24c for reprocessing.

The general computer system 2 may further comprise a content and colour detection program (not shown), which when launched by the control program 24b passes images through a content detection API or any other suitable content detection software to identify any distinguishable objects or colours that may be shown by the image. Such objects may include, but are not exclusively, animals, furniture, geographical features such as mountains or lakes, plants, tourist attractions and landmarks, vehicles, or any other identifiable shape.

Upon identifying an object, the image processing program 24c may then tag the image with at least one term describing or associated with that object. For example, the object detection API may identify a Labrador dog, in which case the image processing program 24c may tag the image with the words “Labrador” and “dog”. As another example, the object detection API may identify Tower Bridge, causing the image processing program 24c to tag image with words such as “Tower Bridge”, “bridge”, “London” and the like.

Classifiers may also be used to suggest tags for an image based on the detected content, wherein other information which has been previously associated the detected content is presented to the user as a potentially relevant tag. Such classifiers may be input manually, or be based on the frequency at which different tags are used together within previously uploaded images. For example, a user standing next to “Tower Bridge” may take a photo of the landmark, but incorrectly label the image as “London Bridge”. However, the distinctive shape of “Tower Bridge” may have been detected in other photos uploaded to the platform which have the labelled “Tower Bridge”, along with other information such as the geographical coordinates of the user at the time they captured the image. The classification API will identify other tags associated with this specific shape and geographical coordinates, such as “Tower Bridge”, and present them to the user as options.

Other objects that may be detected by the content detection API and with which the image may be tagged include logos, terms, slogans and the like associated with commercial brands. Using classifiers, individual brands may then also be associated with other tag words frequently used in conjunction with that brand. For example, if a brand is commonly associated with a particular establishment, the classification API will present said brand as a possible tag when a user uploads an image having the geographical location of that establishment. Such classifiers may be input to the classification API manually, or alternatively, the classification API may develop such classifiers by analysing images previously uploaded to the database 24a.

The general computer system 2 may also comprise a resolution detection program (not shown), which when launched by the control program 24b passes images through a resolution API to measure the level of resolution that the image has, including but not exclusively, measuring the pixel resolution, spatial resolution, spectral resolution or colour depth. Once the resolution has been measured, the image processing program 24c may then tag the image with those measurements. For example, the resolution API may measure a pixel resolution of 3.1 megapixels, the image processing program 24c therefore tagging the image with this measurement.

Once images have been uploaded and processed, images deemed to be public are available to be searched by a third party. FIG. 3a illustrates the search and view stage 3 that may be implemented by the computer system 2 to enable a third party to search and view images marked as public in a chronological order according to embodiments of the present invention.

The search and view stage 3 starts with the user inputting a search criteria (step 3a) into the input box 48c of a user interface 5 displayed to the third party user on their visual display device 23a, as illustrated by FIGS. 5a-b. The search criteria may include any key words that may relate to the image, for example, the geographical location of the image, an event occurring in the image or a particular object shown in the image. The user may also limit the search by setting the time frame, for example, by using a slider 52 to set the period of time for which they would like to view images. The time frame may be any length of time, that is, minutes, hours, days, months or years, such that the user is able to view any images relevant to their search criteria that were captured during this time frame. The user interface 5 may also include geographical filters 53, 54 to enable the user to limit their search to a geographical location, freeing the input box 48c for other terms relating to the desired images, such as an object or event. For example, to search baseball games occurring in New York, USA in May 2014, the user could input “baseball game” to the input box 51, “New York” to the location filter 54, “United States of America” to the country filter 53, and set the time frame slider 52 to “1 May 2014” to “31 May 2014”. Additionally, the user interface 5 may include a menu 55 presenting the user with the option to change the order in which the images are presented, for example, oldest to newest. The user interface 5 may be provided with a further filter (not shown) relating to the resolution of the image, for example, the third party user may wish to narrow theirs search to images of a certain quality and so may wish to search for images that are 5 mega pixels and above.

Upon receipt of the search criteria and the instructions to search images based on this criteria, the control program launches an image search programme 24f which searches (step 3b) through the images in the public table of the database 24a. By placing the images deemed suitable for public access in a separate table, the so-called public table, the amount of images that the image search programme 24f has to filter out and search through is significantly reduced. That is to say, the image search programmed 24f does not have to go through the process of eliminating those marked private and can focus its search solely on the search criteria input by the user. The search and view stage 3 is thus more efficient, which subsequently increases the speed at which the search is performed.

The image search programme 24f will conduct its search based primarily on the EXIF information extracted from the images by the metadata extraction program 24e, along with the words and information that the images have been tagged with upon uploading the image, or by the image processing program 24c after passing the image through the content detection API and resolution API, as described previously. When a geographical location has been searched, the image search program 24f will search for images taken within a radius of the searched location, such that any images with longitude and latitude co-ordinates within that radius will be presented to the user. For example, if the user was to search “Trafalgar Square”, the image search program 24f may search for all images take within a 1 mile radius of Trafalgar Square. The size of the search radius may be predetermined by the image search program 24f, however, the user may also adjust the size of the search radius via the settings icon 48b or an additional search filter (not shown). Once the image search program 24f has identified all of the images relevant to the search criteria it puts the results into chronological order (step 3c) based on the time and date that the images were captured and displays results to the third party (step 3d) on their visual display device 23a via the user interface 5, wherein the images are displayed in a chronologically ordered list 51, for example, the most recently captured image being presented to the third party as the first result 51a.

If the search criteria has not been met (step 3e), the third party user is able to narrow the search criteria by using filters 52, 53, 54 (step 3f), for example, to specify a more precise geographical location or a particular interval of time, as described previously. Once these filters have been input, the image search program 24f will perform a further search 30 as illustrated by FIG. 3b and repeat display process (steps 3c-d), presenting the user with a new set of results 51. Upon receipt of the additional filters, the image search program 24f will search the private table of the database 24a for images that meet this new search criteria (step 30a) to search for any relevant images (step 30b). If there are no new images, the search is ended (step 30c) and the images displayed at step 3d of FIG. 3a remain unchanged. If there are new images identified, the user interface 5 is refreshed showing the new set of images (step 30d), which may or may not include images already presented to them at step 3d.

If the search criteria has been met (step 3e) and the third party user has found an image of interest such that their search is complete (step 3g), the third party user may then select individual images to edit, download, save, print or share (step 3h). Even once the image search programme 24f has identified and displayed images relevant to the third party user's search criteria, the image search programme 24f may continue to run the search and display process (steps 3b-3d) in real time so as to continually update the search.

Preferably, the image processing program 24c and image search programme 24f continuously operate such that a search may be updated at least every minute with any new images that have been uploaded and are relevant to the search criteria, this additional search 300 being illustrated in more detail by FIG. 3c. Preferably, the image search programme 24f will automatically perform a search (step 300a) based on the user's search criteria 3a at least every 5 seconds for the duration that the user is viewing the view and search interface 5. The image search programme 24f will identify any new results (step 300b), that is, new images that have been processed, marked as public, added to the private table of the database 24a and found to match the search criteria. New results identified by the image search programme 24f may also include images that have been edited by the owner of the image, as shown by FIGS. 7b-c, the edited images being subsequently reprocessed by the image processing programme 24c and found to match the search criteria as a result of the editing. For instance, an image may have initially been tagged with an incorrect location or a location spelt incorrectly, for example, “Grenwich”. Upon noticing the error, the user edits the location, for example, so that the location reads “Greenwich”, using the “Edit location or description” icon 79a shown in FIG. 7b and then saves this corrected location using the “Save” icon 79c shown in FIG. 7c. As described previously, upon selecting the “Save” icon 79c the image is reprocessed by the image processing programme 24c. Consequently, the image will now appear as a result in any searches for “Greenwich”. If any new images are identified, the image processing program 24c will deduct the total number relevant images identified from the number of images already being displayed to the user via the user interface 5 (step 300c). If this number is more than 0, the image search program 24f will communicate this to the user via a visual change to the updates icon 49 (step 300d), for example, a change in colour, presentation of a symbol or a number indicating the number of updates, as illustrated by FIG. 5b. Alternatively, the user can select the update icon 49 such that the image processing program 24f repeats the additional search of FIG. 3c and refreshes the list of results 51.

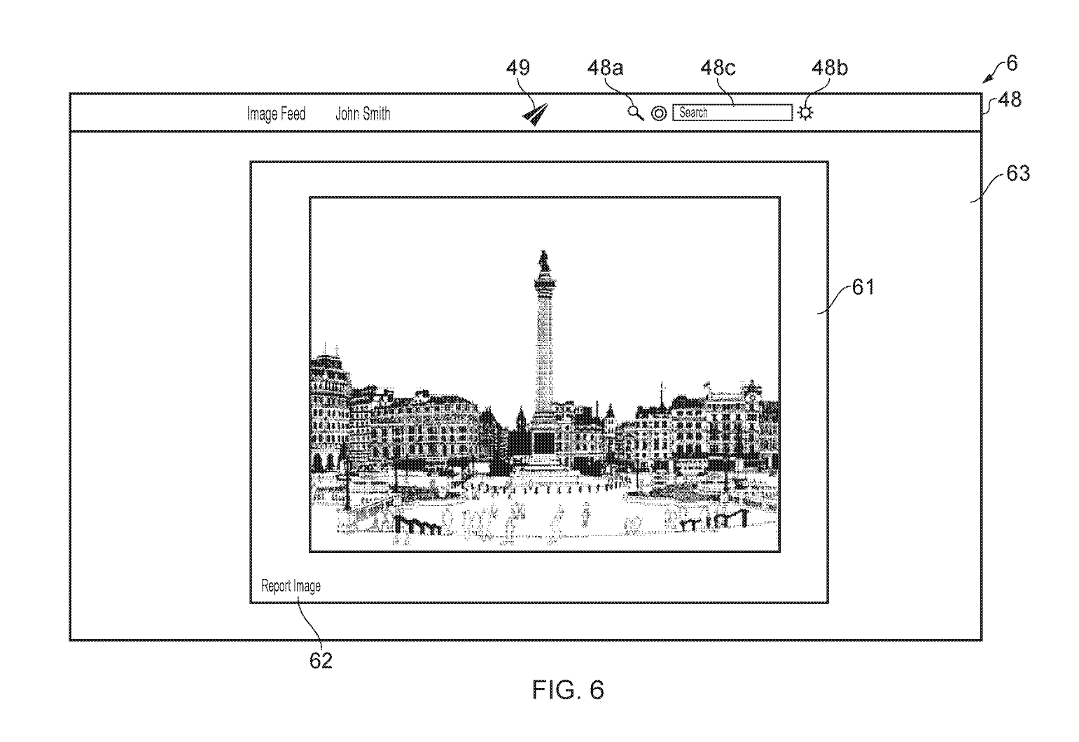

Once the user has been provided with a list of results 51, the user may select an individual image to view in more detail, as shown by FIG. 6. Upon selection of the individual image, the user is presented with a full size version of the image 61. The user interface 6 upon which the full size image 61 is displayed may or may not include information regarding the user that uploaded the image 61. The full size image 61 includes a “Report Image” option 62 should they consider the image to be adverse or offensive, selection of which sends a message to the administrator informing them the image requires their attention and may need to be removed from the platform. Once the user has finished viewing the full size image 61, the user may click anywhere on the user interface 6, preferably, on the background 63 behind the full size image 61, to return to the search and view user interface 5 so that they may view other results 51, or start a new search. Alternatively, the user may be provided with a cancel icon (not shown) to close the full size image 61 and return to the search and view user interface 5.

Once a small number of images in a particular geographical area have been uploaded to the database 24a, a mapping API may be implemented in order to map every longitudinal and latitudinal coordinate within that geographical area. The coordinates mapped within this geographical region will then automatically be associated with a number of tags, preferably, those used previously in connection with this geographical region. For example, two users who are in close proximity, for example, within 100 metres of each other upload images to the platform, as described above. From the geographical coordinates of these two images, the mapping API will scan the region around these two sets of coordinates (for example, within a 500 metre radius of these coordinates), and map every single coordinate within this region. A classification API, as described previously, may then be run to classify each coordinate based on tags previously used in that geographical region, including the tags used by the two users. Subsequently, for any future images uploaded with coordinates in that geographical region, the user will be presented with suggested terms with which to tag their image. Preferably, the image will also be automatically tagged with geographical location associated with that specific coordinate.

For example, three users, who are all standing at different points in front of a stage at Glastonbury, upload images with the tags “Main Stage” and “Glastonbury”. The mapping API will scan the region to get all of the geographical coordinates contained therein. These geographical coordinates will be saved to the database 24a and classified with related terms, such that for any future images uploaded within the mapped geographical region, the user will be presented with terms such as “Main Stage” and “Glastonbury” as potentially suitable tags for their image.

Alternatively, the mapping API may be implemented to map a geographical area without the need for images to have been uploaded in that geographical area previously. Once an area to be mapped is selected, the mapping API will scan the area for all of the latitude and longitude coordinates contained within that that area. The mapping API will then tag the coordinates mapped within this geographical region with the relevant geographical location, as well as any other information related to this geographical location such as points of interest or landmarks. Subsequently, for any future images uploaded with coordinates in that geographical region, the image will also be automatically tagged with geographical location associated with that specific coordinate and the user presented with other suggested terms with which to tag their image.

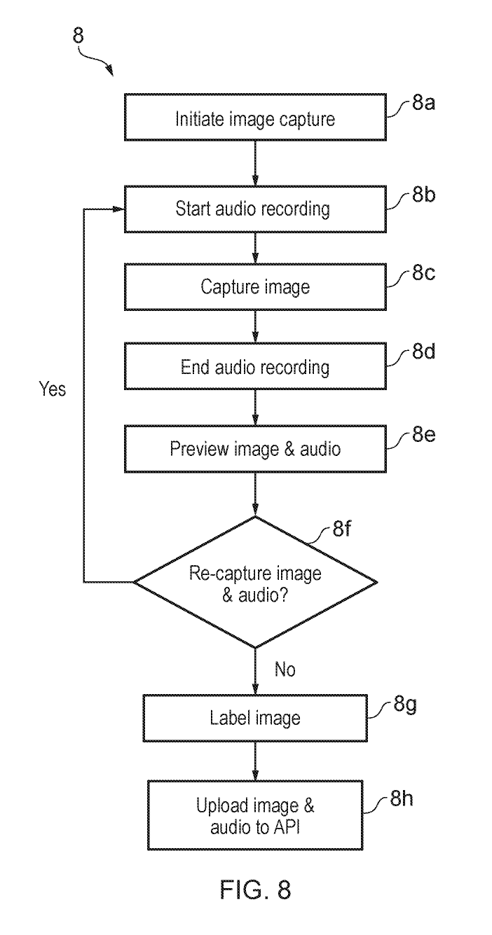

A further feature will now be described with reference to FIG. 8, which illustrates a process of capturing an image and recording audio together. Before uploading an image to the image database as described above, the user may first be presented with the option to simultaneously record an audio file whilst capturing an image. This image and audio capture process 8 starts when a user initiates image capture (step 8a), for example, by selecting the

“Take Photo” icon 403 on the user interface 4 of mobile phone device 400, as illustrated in FIG. 4c. Likewise, the image and audio capture process 8 may implemented by any suitable electronic device capable of capturing an image and recording sound.

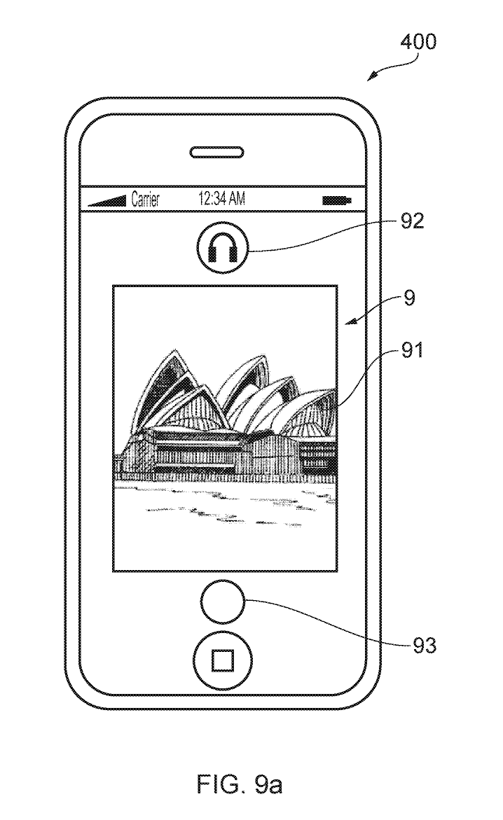

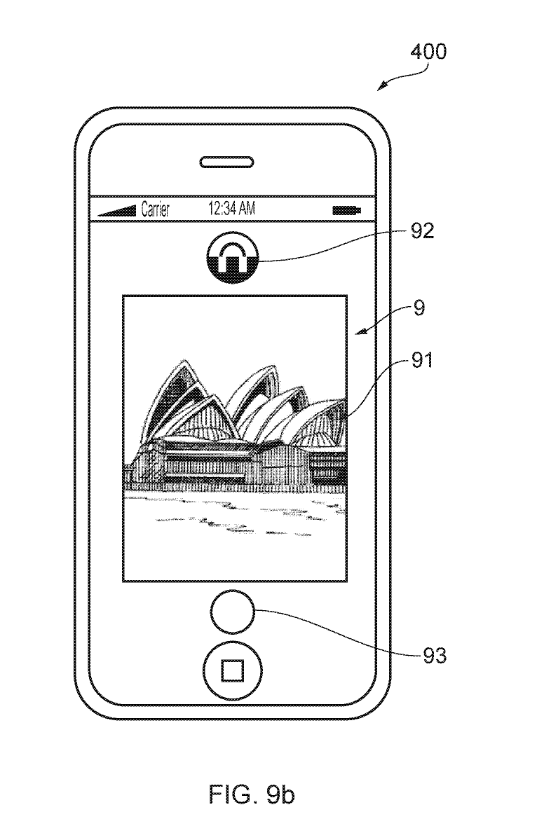

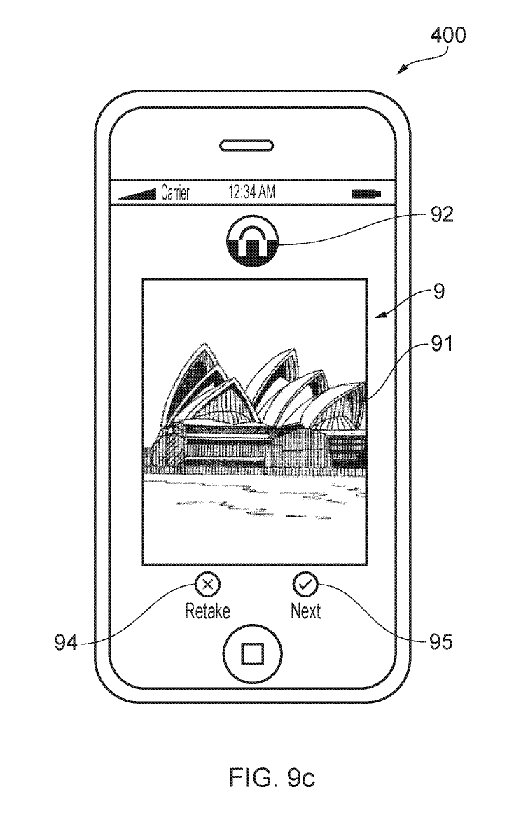

The mobile phone device 400 may then present a new user interface 9 for capturing the image and recording an audio file, as shown in FIGS. 9a-c. Upon initiating image capture such that the camera view finder 91 is triggered, the device 400 begins to record sound using the built in microphone (step 8b). The recording of the sound bite is shown visually via an icon 92, which changes visually as sound is recorded. For example, the icon 92 may gradually change colour, as illustrated by FIG. 9b. The mobile phone device 400 will record sound for at least a pre-determined length of time, for example, five seconds, and then continue to record sound until the user captures an image (step 8c) using the image capture icon 93, at which point no further audio will be recorded (step 8d). The sound bite of interest is the last 5 seconds to be recorded, that is, the last 5 seconds before the image was captured. The sound recorded prior to the last 5 seconds is discarded.

Optionally, if the user does not want to record any sound with the image, the user can select the audio icon 92 to turn off sound recording. Whether the audio feature is on or off may be shown by some further visual identification, for example, a colour change in the audio icon 92.

The user can then review the image and the sound recording (step 8e) and given the option as to whether they wish to upload the image and audio to the memory 21 (step 8f). If they are not satisfied with the image and/or the audio captured, steps 8b to 8e can be repeated to recapture the image and audio sound bite, for example, by selecting the “Retake” icon 94 as shown by FIG. 9c. If the user is satisfied with the image and audio captured, the user can proceed to upload the image and recorded audio as described above with reference to FIGS. 4a-c, for example, by selecting the “Next” icon 95. As before, the image may first be tagged with information relating to the image (step 8g). Such information may include the geographical location of the image, which may be provided automatically via the GPRS capabilities of the electronic device being used, manually by the user or automatically extracted from the Exchangeable Image File Format (EXIF) information embedded in the image, and information relating to the content of the image, as discussed above.

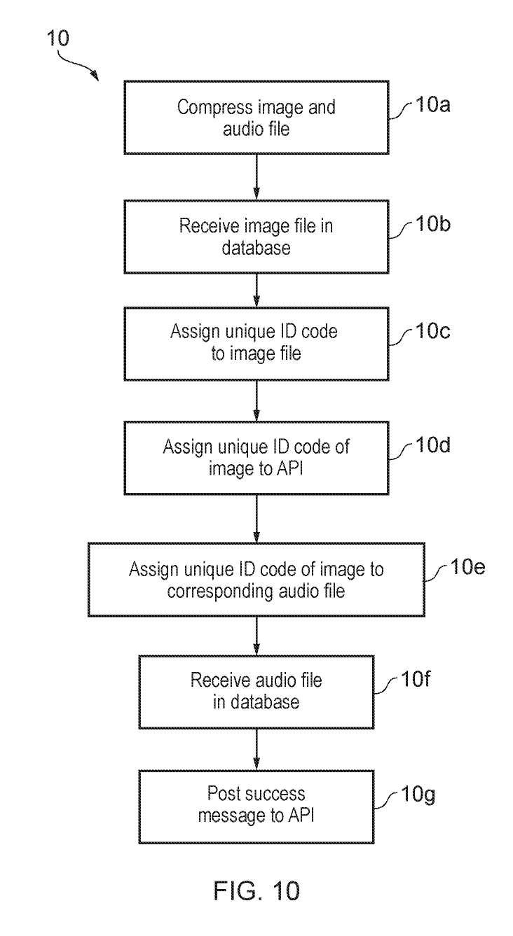

Once satisfied, the user then posts the captured image and recorded audio (step 8h) to the control API 24a for processing, as illustrated by FIG. 10. The control program 24b will then launch the image processing program 24c and audio processing program 24g to compress the image and audio recording (step 10a) to a suitable size, for example, 150 to 160 kilobytes (kB). The audio file may be in any suitable format, for example, an MP4 file format, a waveform audio file format (WAV), free lossless audio codec (FLAC), audio interchange file format (AIFF), or any other standardized means for storing digital audio, and the image may be in any image file format, such as JPEG, GIF, or TIFF.

The image file is then sent to the database 24a (step 10b) where it is assigned a unique ID code (step 10c). The image file may then processed as described above with reference to FIG. 1 so as to be made publicly or privately available based on their content. The unique ID code of the image is then posted back to the API (step 10d) where it is assigned to the corresponding audio file (step 10e) so as to match the audio with correct image within the database 24a. Once labelled with a unique ID, the audio file is also sent to the database 24a where it is stored (step 10f). Upon receipt of the audio file, a success message is posted to the API (step 10g) to notify the user that the image and audio file have been successfully uploaded to the database, such that it can be viewed in the user's personal profile such as that shown in FIGS. 4a-b.

By labelling the image and audio file with the same unique ID code, any time the image is viewed, for example, by the user on their personal profile or by another user during the search and view stage shown in FIGS. 3a-b, the audio file can be quickly identified and presented to the viewer along with the image. The audio file may automatically play as soon as the image is displayed, or the viewed may be required to initiate playback, for example, by selecting a “play” icon or by clicking on the image itself.

Another feature may the use of a speech recognition API within the platform. Such software may be used to tag the image during the upload and process stage 1, or to search for images in the search and view stage 3. As described above, once an image has been captured or selected for uploading, the user is presented with the opportunity to tag the image with relevant information, such as that relating to its content or geographical location, or any other words the user associates with the image. Using a microphone integrated in or connected to the personal device being used to upload the image, the user may record a small sample of them talking, the recorded speech then being passed through a speech recognition API. The recorded speech may be saved as an audio file, as described with reference to FIGS. 8 to 10, or it may be discarded once received by the speech recognition API. The speech recognition API will process the detected speech, and convert the speech into text with which the image processing program 24c will tag the image.

Similarly, during the search and view stage 3, the user may use the speech recognition API to input their search criteria. For example, if a user wanted to search for pictures of kittens, the user may say “kittens” or “search kittens” into the microphone of the device being used. The speech recognition API will process this speech and convert it into text, and then communicate the command to the image search program 24g. Upon receipt of the command, the image search program 24g will run as described with reference to FIGS. 3a-c so as to present the user with pictures that meet the search criteria. If the search criteria has not been completely met, the user may then filter the search results, again by using a spoken command passed through the speech recognition API.

Another feature may the use of a sound recognition API within the platform. Such software may be used to tag the image during the upload and process stage 1, or to search for images in the search and view stage 3. As described above, once an image has been captured or selected for uploading, the user is presented with the opportunity to tag the image with relevant information. Using a microphone integrated in or connected to the personal device being used to upload the image, the user may record a small sample of a sound, the recorded sound being passed through a sound recognition API. The sound recognition API may be arranged to recognise any common place sounds such as birdsong, the sound of rain or a dog barking. The sound recognition API may also be able to recognise popular music such as songs by recording artists. The recorded sound may be saved as an audio file, as described with reference to FIGS. 8 to 10, or it may be discarded once received by the sound recognition API. The sound recognition API will process the detected sound, and identify information relevant to the detected sound. Such information may include words associated with the sound, or in the case of a song, the name of the song and/or the artist. Such information may then be used by the image processing program 24c to tag the image.

Similarly, during the search and view stage 3, the user may use the sound recognition API to input their search criteria. For example, if a user wanted to search for pictures relating to Kylie Minogue, the user may play a song by Kylie Minogue into the microphone of the device being used. The sound recognition API will process this song and identify terms relating to that song, these terms then being communicated to the image search program 24g as the search criteria. Upon receipt of the search criteria, the image search program 24g will run as described with reference to FIGS. 3a-c so as to present the user with pictures that relate to the search criteria. Various modifications, whether by way of addition, deletion or substitution may be made to the above described embodiments to provide further embodiments, any and all of which are intended to be encompassed by the appended claims.

1. An image processing method comprising the steps of:
receiving at least one image file from a client application;
analysing the at least one image file to determine whether the image includes a face;
if the image includes a face, assigning the image file to a first group of images, wherein the first group of images is accessible by a client application having a first user profile; and
if the image does not include a face, assigning the image file to a second group of images, wherein the second group of images is accessible by a client application having a second user profile.

2. A method according to claim 1, wherein the step of receiving comprises storing the at least one image file in a database.

3. A method according to claim 1, wherein the step of receiving further comprises receiving instructions from the client application to label the image file with at least one identifying term.

4. A method according to claim 3, wherein the identifying term is based on at least one of: the geographical location where the image was captured, the time at which the image was captured and the visual content of the image.

5. A method according to claim 1, wherein the step of analysing the at least one image file further comprises inputting the image file to a face detection application programming interface, API.

6. A method according to claim 1, wherein the step of analysing the at least one image file further comprises extracting metadata information embedded in the image file.

7. A method according to claim 6, wherein the metadata information includes at least one of the geographical location where the image was captured and the time at which the image was captured.

8. A method according to claim 7, wherein the step of analysing the at least one image file further comprises labelling the image file with at least one identifying term based on the geographical location.

9. A method according to claim 1, wherein the step of analysing the at least one image file further comprises inputting the image file to a content detection application programming interface, API.

10. A method according to claim 9, wherein the step of analysing the at least one image file further comprises labelling the image file with at least one identifying term based on the content detected by the content detection API.

11. A method according to claim 1, wherein the method further comprises the steps of:
receiving instructions from a client application of the second user profile to search the images that do not include a face, wherein the instructions comprise at least one search criterion; and
displaying at least one image to the client application of the second user profile based on the received instructions.

12. A method according to claim 11, wherein the search criterion includes at least one of: a geographical location, a time frame, an event and an object.

13. A method according to claim 11, wherein the method further comprises the step of displaying the at least one image to the client application of the second user profile in a chronological order.

14. A method according to claim 13, wherein the chronological order is based on the date and time at which the image was captured.

15. A method according to claim 1, wherein the method further comprises receiving at least one audio file from the client application, wherein the audio file is associated with at least one image file.

16. A method according to claim 15, wherein the method further comprises receiving instructions from a client application of the second user profile to search the images that do not include a face based on an associated audio file.

17. A non-transitory computer program product for a data-processing device, the computer program product comprising a set of instructions which, when loaded into the data-processing device, causes the device to perform the steps of the method of claim 1.

18. An image processing system, comprising:
at least one client application running on a data processing device; a processor; and
a computer readable medium storing one or more instruction(s) arranged such that when executed the processor is caused to perform the method of claim 1.

19. A system according to claim 18, wherein the processor is further arranged such that analysis of at least one image is initiated in response to a request from a client application.
